(19) United States
(12) Patent Application Publication
(10) Pub. No.: US 2016/0061292 A1
(43) Pub. Date: Mar. 3, 2016

(54) ECCENTRIC OSCILLATION GEAR DEVICE AND TORQUE ADJUSTING METHOD THEREFOR

(71) Applicant: NABTESCO CORPORATION, Tokyo (JP)

(72) Inventors: Hiroki MIZUHASHI, Mie (JP); Jun IKEDA, Mie (JP)

(21) Appl. No.: 14/833,757

(22) Filed: Aug. 24, 2015

(30) Foreign Application Priority Data
Aug. 28, 2014 (JP) 2014-173758

(51) Int. Cl. F16H 1/32; F16H 57/08

(52) U.S. Cl. CPC F16H 1/32; F16H 57/082; F16H 2001/323

(57) ABSTRACT

Disclosed is an eccentric oscillation gear device which comprises: an outer cylinder; a carrier provided with a plurality of motor installation sections; a main bearing configured to permit relative rotation between the outer cylinder and the carrier; one or more motors installed in a part of the plurality of motor installation sections; and a crankshaft configured to be rotated in response to receiving a driving force from the one or more motors, in such a manner as to cause relative rotation between the outer cylinder and the carrier.

### TECHNICAL FIELD

The present invention relates to an eccentric oscillation gear device and a method of adjusting torque of the eccentric oscillation gear device.

### BACKGROUND ART

Heretofore, there has been known an eccentric oscillation gear device comprising a plurality of crankshafts and a plurality of motors each configured to driven a respective one of the crankshafts, as disclosed in JP 2011-147223A and JP H02-041748U. For example, an eccentric oscillation gear device disclosed in JP 2011-147223A is configured such that an outer cylinder 91 and a carrier 92 are relatively rotatable with respect to each other via a bearing 93, as illustrated in FIG. 9. Additionally, a plurality of crankshafts 94 are rotatably supported by the carrier 92, and a plurality of motors 95 are attached to the crankshafts 94, respectively. When the crankshafts 94 are rotated by the respective motors 95, an oscillation gear 96 fitted on the crankshafts 94 is oscillatingly rotated, and thereby the carrier 92 is relatively rotated with respect to the outer cylinder 91.

In this type of eccentric oscillation gear device disclosed in JP 2011-147223A and JP H02-041748U, the crankshafts are rotated by driving force generated from the plurality of motors. Therefore, it becomes possible to increase a torque for rotating the crankshafts, i.e., the carrier or outer cylinder, as compared to an eccentric oscillation gear device using only one motor.

In a design and production process of a gear device, a motor appropriate to a required torque is selected, and then a carrier and others are selected in accordance with the motor. In the design and production process, if a motor and others are selected after finalization of the required torque, it becomes difficult to meet a delivery deadline for the gear device, in some cases. Thus, it is necessary to preliminarily ensure a certain level of stocks so as to achieve quick delivery of the gear device. In reality, however, the required torque can be changed from an initial specification. For making it possible to cope with such a situation, it is necessary to ensure stocks for a plurality of types of gear devices equipped with different motors according to various specifications. This causes storage space problems and production control problems.

### SUMMARY OF INVENTION

It is therefore an object of the present invention to provide an eccentric oscillation gear device capable of readily coping with a change of a required torque and contributing to a reduction in burden of stocks.

According one aspect of the present invention, there is provided an eccentric oscillation gear device which comprises: an outer cylinder; a carrier provided with a plurality of motor installation sections; a main bearing configured to permit relative rotation between the outer cylinder and the carrier; one or more motors installed in a part of the plurality of motor installation sections; and a crankshaft configured to be rotated in response to receiving a driving force from the one or more motors, in such a manner as to cause relative rotation between the outer cylinder and the carrier.

According another aspect of the present invention, there is provided a method of adjusting torque of an eccentric oscillation gear device, wherein the eccentric oscillation gear device comprises: an outer cylinder; a carrier provided with a plurality of motor installation sections; a main bearing configured to permit relative rotation between the outer cylinder and the carrier; one or more motors installed in at least a part of the plurality of motor installation sections; and a crankshaft configured to be rotated in response to receiving a driving force from the one or more motors, in such a manner as to cause relative rotation between the outer cylinder and the carrier. The method comprises: selectively determining the number of the motors according to a required torque, within a total number of the motor installation sections; and installing the determined number of the motors, respectively, in a same number of ones of the motor installation sections, thereby adjusting a relative rotation torque to be generated between the outer cylinder and the carrier.

### BRIEF DESCRIPTION OF DRAWINGS

FIG. 1 is a sectional view of an eccentric oscillation gear device according to one embodiment of the present invention, taken along the line I-I in FIG. 2.

FIG. 2 is a sectional view taken along the line II-II in FIG. 1.

FIG. 3 is a side view of the eccentric oscillation gear device, when viewed rightwardly from the left side in FIG. 1, wherein plugging members are removed therefrom.

FIG. 4 is a sectional view taken along the line IV-IV in FIG. 2.

FIG. 5 is a view corresponding to FIG. 2, which illustrates an example where three motors are installed.

FIG. 6 is a view corresponding to FIG. 3, which illustrates an example where three motors are installed.

FIG. 7 is a sectional view of an eccentric oscillation gear device according to another embodiment of the present invention.

FIG. 8 is a sectional view of an eccentric oscillation gear device according to yet another embodiment of the present invention.

FIG. 9 is an explanatory diagram of a conventional eccentric oscillation gear device.

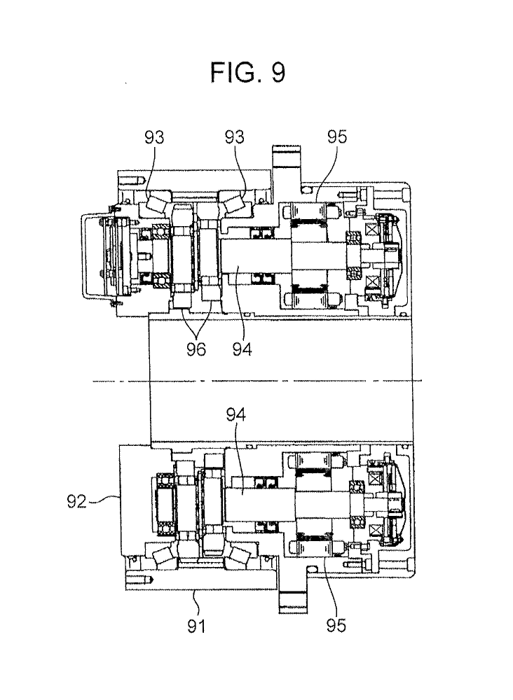

### DESCRIPTION OF EMBODIMENTS

With reference to the drawings, one embodiment of the present invention will now be described in detail.

A gear device 1 according to this embodiment is designed to be applicable as a speed reducer, for example, to turning sections in a turning body, an arm joint and the like of a robot, and turning sections of various machine tools. For example, the gear device 1 is a gear transmission device provided between a base and a turning body relatively turnable with respect to the base and configured to output a driving force having a rotational speed reduced at a given ratio with respect to a rotational speed input thereto.

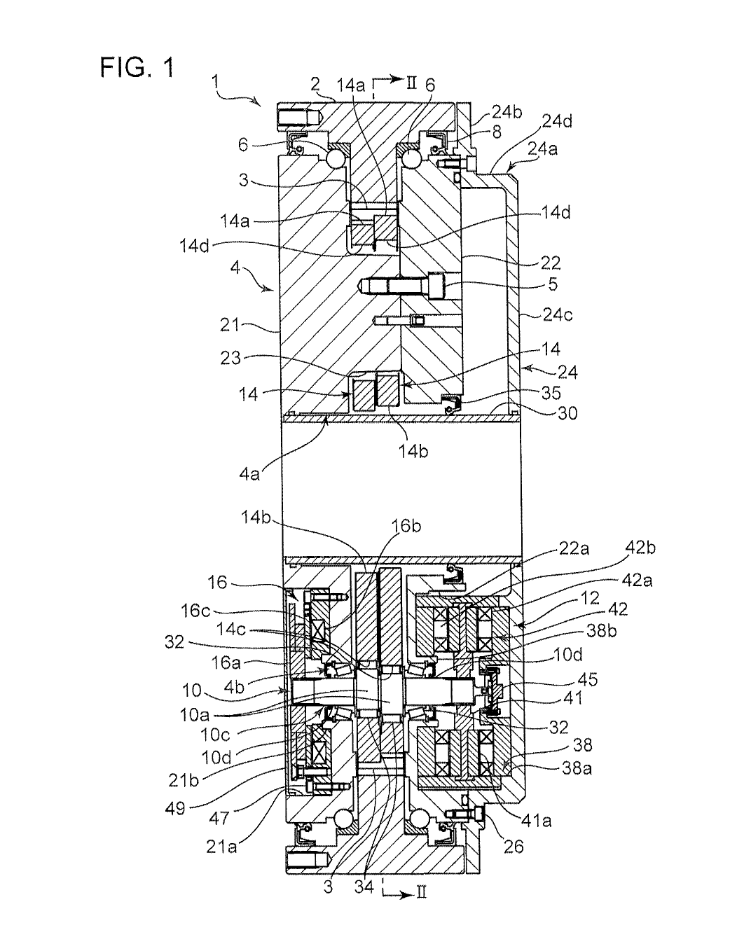

As illustrated in FIG. 1, the gear device 1 according to this embodiment comprises an outer cylinder 2, an internal-teeth pin 3, a carrier 4, a main bearing 6, a crankshaft 10, a motor 12, an oscillation gear 14, and a brake 16.

The outer cylinder 2 is configured to be fixable to one (e.g., a base of a robot) of two counterpart members, and is capable of functioning as a casing of the gear device 1. The outer cylinder 2 is formed into an approximately circular cylindrical shape having an inner peripheral surface. Specifically, the outer cylinder 2 is fastened to the base of the robot by a bolt (fastener) or the like.

A large number of the internal-tooth pins 3 are arranged on the inner peripheral surface of the outer cylinder 2 at even intervals in a circumferential direction of the inner peripheral surface. The internal-tooth pins 3 function as internal teeth meshable with teeth 14a of the oscillation gear 14 composed of an externally toothed gear. The number of the teeth 14a of the oscillation gear 14 is set to be slightly less than the number of the internal-tooth pins 3. In this embodiment, the oscillation gear 14 is used plurally (e.g., two).

The carrier 4 is configured to be fixable to the other counterpart member (e.g., a turning body of the robot). Specifically, the carrier 4 is fastened to the turning body of the robot by a non-illustrated bolt (fastener) or the like. The carrier 4 is housed inside the outer cylinder 2 while being disposed in a coaxial relation to the outer cylinder 2. The carrier 4 is supported by a pair of the main bearings 6 provided in axially spaced-apart relation, in such a manner as to be relatively rotatable with respect to the outer cylinder 2. Thus, the carrier 4 is relatively rotatable with respect to the outer cylinder 2, about a common axis. When the carrier 4 is relatively rotated with respect to the outer cylinder 2, the turning body of the robot is turned with respect to the base.

It should be noted that, although FIG. 1 illustrates an example where each of the main bearings 6 has an outer race composed of a member separate from the outer cylinder 2, and an inner race composed of a portion of the carrier 4, the embodiment is not limited thereto. For example, the main bearing 6 may have an outer race composed of a member separate from the outer cylinder 2, and an inner race composed of a member separate from the carrier 4. Alternatively, the main bearing 6 may have an outer race composed of a portion of the outer cylinder 2, and an inner race composed of a member separate from the carrier 4.

Further, although this embodiment shows an example where the carrier 4 is fastened to the turning body in a rotatable manner, and the outer cylinder 2 is fixed to the base in an immovable manner, the reverse arrangement may be employed. That is, the outer cylinder 2 may be fastened to the turning body, and the carrier 4 may be fastened to the base. In this case, when the outer cylinder 2 is relatively rotated with respect to the carrier 4, the turning body of the robot is turned with respect to the base. An oil seal 8 is provided between the outer cylinder 2 and the carrier 4.

The carrier 4 comprises a base plate portion 21, an end plate portion 22, a shaft portion 23, and a cover portion 24. The base plate portion 21 is disposed inside the outer cylinder 2 at a position adjacent to one end of the outer cylinder 2 in a direction of a rotational axis (i.e., axial direction) of the carrier 4. The shaft portion 23 axially extends from the base plate portion 21 toward the end plate portion 22. The shaft portion 23 is provided plurally (in this embodiment, six), wherein the shaft portions 23 are arranged at circumferentially even intervals. It should be understood that, although the carrier 4 in this embodiment has a structure in which the base plate portion 21 and the shaft portions 23 are integrally formed as a carrier base, the embodiment is not limited thereto. That is, the shaft portions 23 do not necessarily have to be formed integrally with the base plate portion 21. More specifically, each of the shaft portions 23 may be formed as a separate body from the base plate portion 21, and fastened to the base plate portion 21 by a fastener such as a bolt. It should be noted that the circumferential intervals of the shaft portions 23 do not necessarily have to be even.

A surface of the base plate portion 21 on a side opposite to the end plate portion 22 is formed with a plurality of (in this embodiment, six) recesses 21a. The recesses 21a are provided around a radially central region of the carrier 4 at even intervals. The recesses 21a are provided in the surface of the base plate portion 21 on a side opposite to a surface thereof provided with the shaft portions 23, and arranged at respective positions between respective pairs of adjacent ones of the shaft portions 23.

The end plate portion 22 is formed into a plate shape having a diameter equal to that of the base plate portion 21, and disposed in spaced-apart relation to the base plate portion 21. A surface of the end plate portion 22 on a side opposite to the base plate portion 21 is formed with a plurality of (in this embodiment, six) recesses 22a. The recesses 22a are provided around the radially central region of the carrier 4 at even intervals.

Each of the shaft portions 23 is fastened to the end plate portion 22 by a bolt (fastener) 5. As a result, the base plate portion 21 and the end plate portion 22 are integrated together. Further, a housing space for housing the oscillation gears 14 is formed between the base plate portion 21 and the end plate portion 22.

The cover portion 24 is disposed on the side opposite to the base plate portion 21 with respect to the end plate portion 22 to cover an outer end surface of the end plate portion 22. The cover portion 24 has a cover body 24a, and a flange 24b formed around the cover body 24a and fastenable to the end plate portion 22.

The cover body 24a has a bottom wall 24c, and a side (outer peripheral) wall 24d extending from an outer periphery of the bottom wall 24c in the axial direction of the carrier 4. That is, the cover body 24a is formed into a bottomed tubular shape in which one of axially opposite ends is opened.

The flange 24b is a portion protruding radially outwardly from an axial distal edge of the side wall 24d. The flange 24b is formed with an insertion hole for allowing a bolt (fastener) 26 to be penetratingly inserted thereinto. It is to be understood that, although the flange 24b is formed to have a size capable of covering one axial end surface of the outer cylinder 2, the embodiment is not limited thereto.

The carrier 4 has a through-hole 4a formed in the radially central region thereof to axially penetrate through the base plate portion 21, the end plate portion 22 and the cover portion 24. A tubular body 30 is fitted into the through-hole 4a in such a manner as to axially penetrate through the carrier 4. It should be noted that the tubular body 30 may be omitted, and the through-hole 4a may also be omitted.

One end of the tubular body 30 is in close contact with an inner peripheral surface of the base plate portion 21 defining a part of the through-hole 4a, and the other end of the tubular body 30 is in close contact with an inner peripheral surface of the cover member 24 defining a part of the through-hole 4a. An oil seal 35 is provided between the end plate portion 22 and an intermediate portion of the tubular body 30. This makes it possible to seal a space defined between the base plate portion 21 and the end plate portion 22, and a space defined between the end plate portion 22 and the cover portion 24.

The carrier 4 has a plurality of (in this embodiment, six) crankshaft holes 4b formed around the through-hole 4a. The crankshaft holes 4b are formed at respective positions between respective pairs of adjacent ones of the shaft portions 23, and arranged at circumferentially even intervals. Each of the crankshaft holes 4b is formed to have a size capable of allowing the crankshaft 10 to be penetratingly inserted thereinto, and penetrate through the base plate portion 21, the end plate portion 22 and the cover portion 24 in the axial direction of the carrier 4. It should be noted that the circumferential intervals of the crankshaft holes 4b do not necessarily have to be even.

Each of the crankshaft holes 4b has a base plate portion-side region which penetrates through a bottom of a corresponding one of the recesses 21a of the base plate portion 21. That is, each of the recesses 21a of the base plate portion 21 is formed to surround a corresponding one of the crankshaft holes 4b. Each of the crankshaft holes 4b also has an end plate portion-side region which penetrates through a bottom of a corresponding one of the recesses 22a of the end plate portion 22. That is, each of the recesses 22a of the end plate portion 22 is formed to surround a corresponding one of the crankshaft holes 4b. Each of the recesses 21a and the recesses 22a has a circular shape, when view along the axial direction of the carrier 4.

The crankshaft 10 is penetratingly inserted into each of the crankshaft holes 4b of the carrier 4. That is, the crankshaft 10 is provided plurally (in this embodiment, e.g., six), wherein the crankshafts 10 are arranged around the radially central region of the carrier 4 at even intervals. Each of the crankshafts 10 has an axial length less than that of the carrier 4, i.e., it is fully housed inside the carrier 4.

Each of the crankshafts 10 is rotatably supported by the carrier 4 via a pair of first and second crankshaft bearings 32, and, in this supported state, installed in a posture where it extends parallel to the rotational axis of the carrier 4. The first crankshaft bearing 32 is fitted into the end plate portion-side region of the crankshaft hole 4b. The second crankshaft bearing 32 is fitted into the base plate portion-side region of the crankshaft hole 4b.

Each of the crankshafts 10 has a crankshaft body 10c, and a plurality of (in this embodiment, two) eccentric portions 10a formed integrally with the crankshaft body 10c. The eccentric portions 10a are disposed in an axially side-by-side relation at respective positions between a pair of journal regions 10d of the crankshaft 10 on which the crankshaft bearings 32 are mounted, respectively. Each of the eccentric portions 10a is formed into a columnar shape whose axis is eccentric with respect to an axis of the crankshaft body 10c by a given eccentric amount. Further, the eccentric portions 10a are formed in the crankshaft 10 to have a phase difference of a given angle therebetween. It should be noted that the number of the eccentric portions 10a may be one, or three or more.

Each of the crankshafts 10 is subjected to spline machining at opposite ends thereof extending outwardly from the respective journal regions 10d.

Each of the oscillation gears 14 is composed of an externally toothed gear having an outer peripheral portion formed with the large number of teeth 14a, and formed to have an outer diameter slightly less than an inner diameter of the outer cylinder 2. Each of the oscillation gears 14 is attached to a corresponding one of the eccentric portions 10a of the crankshaft 10 through a roller bearing 34. The oscillation gears 14 are operable, upon rotation of the respective crankshafts 10, to be oscillatingly rotated interlockingly with eccentric rotation of the eccentric portions 10a of the crankshafts 10, while sequentially changing a meshing position with respect to the internal-tooth pins 3 on the inner peripheral surface of the outer cylinder 2.

Each of the oscillation gears 14 has a central through-hole 14b, a plurality of eccentric-portion insertion holes 14c, and a plurality of shaft-portion insertion holes 14d. The central through-hole 14b is formed in a radially central region of the oscillation gear 14. In the case where the tubular body 30 is omitted, the central through-hole 14b may be omitted.

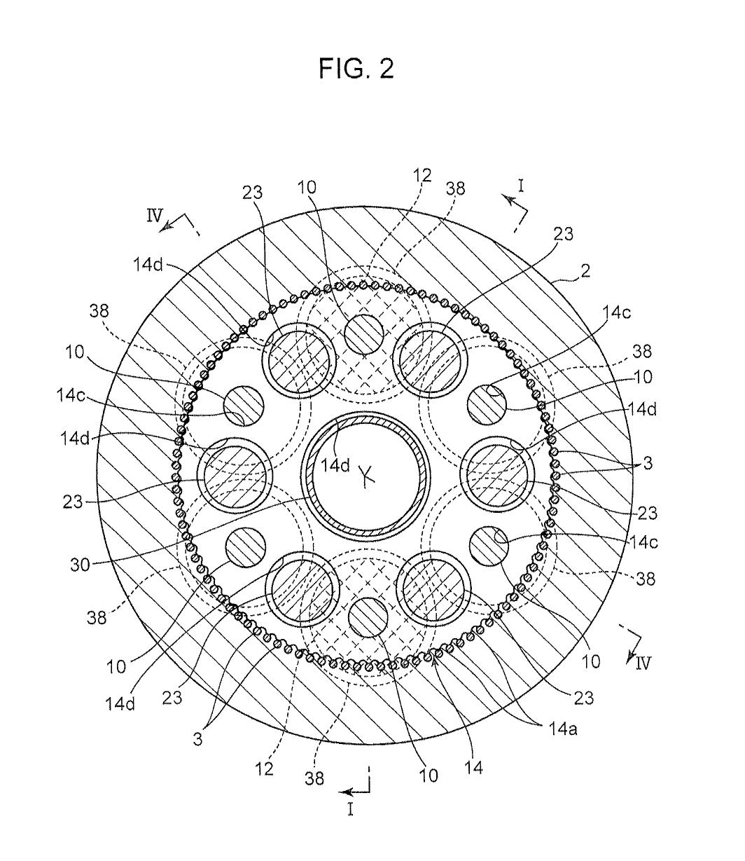

The eccentric-portion insertion holes 14c are provided around the central through-hole 14b of the oscillation gear 14 at circumferentially even intervals. Each of the eccentric portions 10a of the crankshafts 10 is penetratingly inserted in a corresponding one of the eccentric-portion insertion holes 14c, under interposition of the roller bearing 34 therebetween. In FIG. 2, the illustration of the roller bearing 34 is omitted. In the case where the crankshafts 10 are not arranged at circumferentially even intervals, the eccentric-portion insertion holes 14c are provided at respective positions set accordingly.

The shaft-portion insertion holes 14d are provided around the central through-hole 14b of the oscillation gear 14 at circumferentially even intervals. The shaft-portion insertion holes 14d are formed at respective positions between respective pairs of circumferentially adjacent ones of the eccentric-portion insertion holes 14c. Each of the shaft portions 23 is penetratingly inserted into a corresponding one of the shaft-portion insertion holes 14d with a clearance. In the case where the shaft portions 23 are not arranged at circumferentially even intervals, the shaft-portion insertion holes 14d are provided at respective positions set accordingly.

The carrier 4 is provided with a plurality of (in this embodiment, six) motor installation sections 38. Each of the motor installation sections 38 is a portion capable of holding the motor 12, and they are arranged around the radially central region of the carrier 4 at circumferentially even intervals. The motor installation sections 38 are arranged at respective positions corresponding to the positions of the crankshafts 10. Thus, in the case where the crankshafts 10 are not arranged at circumferentially even intervals, the motor installation sections 38 are also not arranged at circumferentially even intervals, correspondingly.

Each of the motor installation sections 38 comprises an axially outer segment 38a provided in the cover portion 24, and an axially inner segment 38b provided in the end plate portion 22.

Each of the axially outer segments 38a of the motor installation sections 38 is provided in the cover body 24a of the cover portion 24 at a position opposed to a corresponding one of the recesses 22a of the end plate portion 22. Each of the axially outer segments 38a is formed integrally with the cover body 24a on an inner surface of the bottom wall 24c of the cover body 24a. Each of the axially outer segments 38a axially protrudes from the bottom wall 24c toward the end plate portion 22 (or the base plate portion 21). Each of the axially outer segments 38a is formed into an annular shape concentric with the corresponding one of the crankshaft holes 4b.

Each of the axially inner segments 38b of the motor installation sections 38 is formed around the crankshaft holes 4b to extend from a bottom of a corresponding one of the recesses 22a formed in the end plate portion 22, toward the cover portion 24, in the axial direction of the carrier 4. Each of the axially inner segments 38b is formed into an annular shape concentric with a corresponding one of the crankshaft holes 4b. Each of the crankshafts 10 is penetratingly inserted into a corresponding one of the axially inner segments 38b.

The motor 12 is disposed inside the carrier 4. The motor 12 comprises a rotor 41 attached to one, first, end (an end on the side of the motor installation sections 38) of the crankshaft 10, and a stator 42 fixed to the carrier 4. The rotor 41 has a radially central portion spline-coupled to the first end of the crankshaft 10, and a radially outer portion to which a magnet 41a is fixed. The stator 42 comprises a coil 42a and an iron core 42b. The motor 12 is composed of an axial gap motor in which the stator 42 and the rotor 41 are axially opposed to each other.

The motor 12 is installed in the motor installation section 38. Specifically, the motor 12 is attached to the motor installation section 38 in such a manner that one axial end (an end on the side of the cover portion 24) of the stator 42 is fitted into a radially inward space of the axially outer segment 38a of the motor installation sections 38, and the other axial end (an end on the side of the end plate portion 22) of the stator 42 is fitted onto the axially inner segment 38b of the motor installation sections 38. The stator 42 is press-fitted into the axially outer segment 38a, so that it is fixed to the axially outer segment 38a (cover plate 24). Further, the axially inner segment 38b is press-fitted into an opening formed in a surface of the other axial end of the stator 42, so that the stator 42 is also fixed to the end plate portion 22. It is to be understood that means to fix the stator 42 is not limited to press-fitting, but the stator 42 may be fixed by a non-illustrated bolt. The first crankshaft bearing 32 is also fitted into the axially inner segment 38b. Thus, the axially inner segment 38b also functions as a supporting section for the crankshaft 10. The stator 42 is fitted on the axially inner segment 38b, so that it becomes possible to facilitate downsizing and enhance supporting rigidity for the crankshaft 10. The motor 12 is disposed on a side opposite to the base plate portion 21 with respect to the end plate portion 22a, and thereby can avoid interference with the shaft portions 23.

The stator 42 is equipped with an encoder 45 for detecting a rotational amount of the crankshaft 10.

The brake 16 comprises: a rotary plate 16a attached to the other, second, end (an end on the side of the base plate portion 21) of the crankshaft 10; an electromagnet 16b fixed to the base plate portion 21 (carrier 4); and a braking plate 16c supported by the electromagnet 16b in an axially reciprocatingly movable manner. The rotary plate 16a has a radially central portion spline-coupled to the second end of the crankshaft 10, wherein it is kept in a posture perpendicular to the crankshaft 10. The braking plate 16c is made of a magnetic material, and can take two states: a braking state in which it is pressed against the rotary plate 16a and a normal state in which it is kept away from the rotary plate 16a according to off-on control of the electromagnet 16b.

The electromagnet 16b is formed into an annular shape, and installed inside the recess 21a of the base plate portion 21. The recess 21a functions as a brake installation section as a section for holding the brake 16. That is, in this embodiment, a plurality of (in this embodiment, six) brake installation sections are provided. The recesses 21a are arranged around the radially central region of the carrier 4 at even intervals, as mentioned above. Each of the recesses 21a is formed into an annular shape which is concentric with a corresponding one of the crankshaft holes 4b and has an opening through which a corresponding one of the crankshafts 10 penetrates. The recesses 21a are provided on a side opposite to the motor installation sections 38 with respect to the oscillation gears 14. Further, the recesses 21a are provided, respectively, at the same positions as those of the motor installation sections 38 in a circumferential direction of the carrier 4

A brake positioning segment 21b which extends outwardly from a bottom of the recess 21a in the axial direction of the carrier 4 is formed on the recess 21a around the peripheral portion of the crankshaft holes 4b. The brake positioning segment 21b is formed into a circular cylindrical shape concentric with the crankshaft hole 4b. The electromagnet 16b has inner edge portion formed with a depression having a shape corresponding to the shape of the brake positioning segment 21b. When the brake positioning segment 21b is fitted into the depression of the electromagnet 16b, the electromagnet 16b is positioned with respect to the base plate portion 21. Then, the electromagnet 16b is fixed to the base plate portion 21 by a bolt (fastener) 47.

The second crankshaft bearing 32 is mounted inside the brake positioning segment 21b. Thus, the brake positioning segment 21b also functions as a supporting section for the crankshaft 10.

The carrier 4 is provided with a plurality of plugging members 49 for plugging respective openings formed by the recesses 21a provided in the base plate portion 21. Specifically, each of the recesses 21a is formed in an axially outer surface of the base plate portion 21, and a space formed by the recess 21a is communicated with the corresponding crankshaft hole 4b. Each of the plugging members 49 plugs an axial end opening of the space in a corresponding one of the recesses 21a.

In this embodiment, as illustrated in FIG. 2, the motor 12 is installed in each of two of the six motor installation sections 38. In FIG. 2, the two motors 12 are arranged around the rotational axis of the carrier 4 at intervals of 180 degrees.

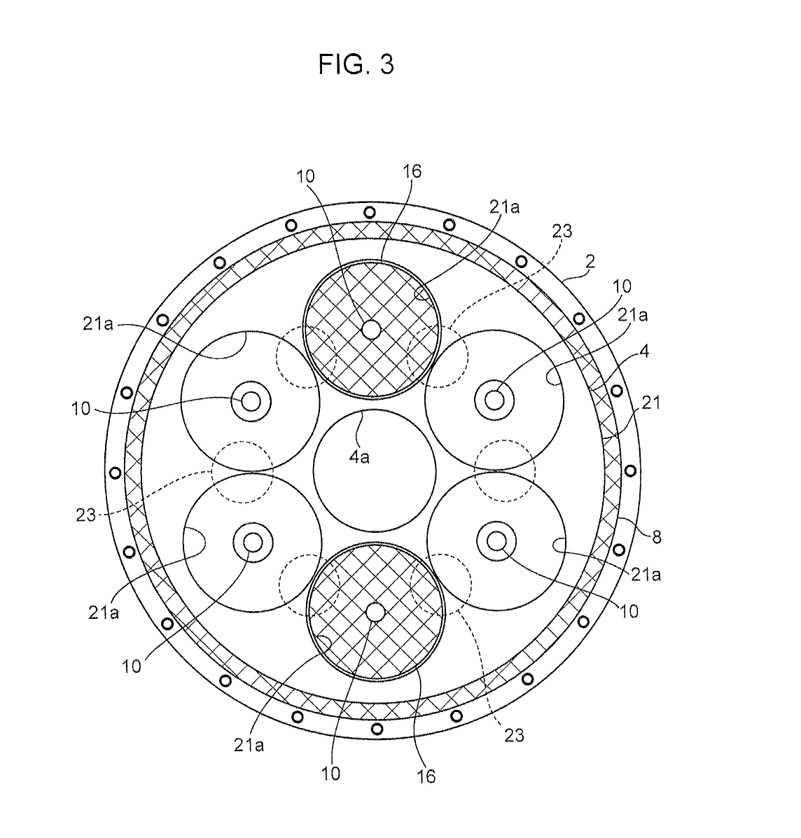

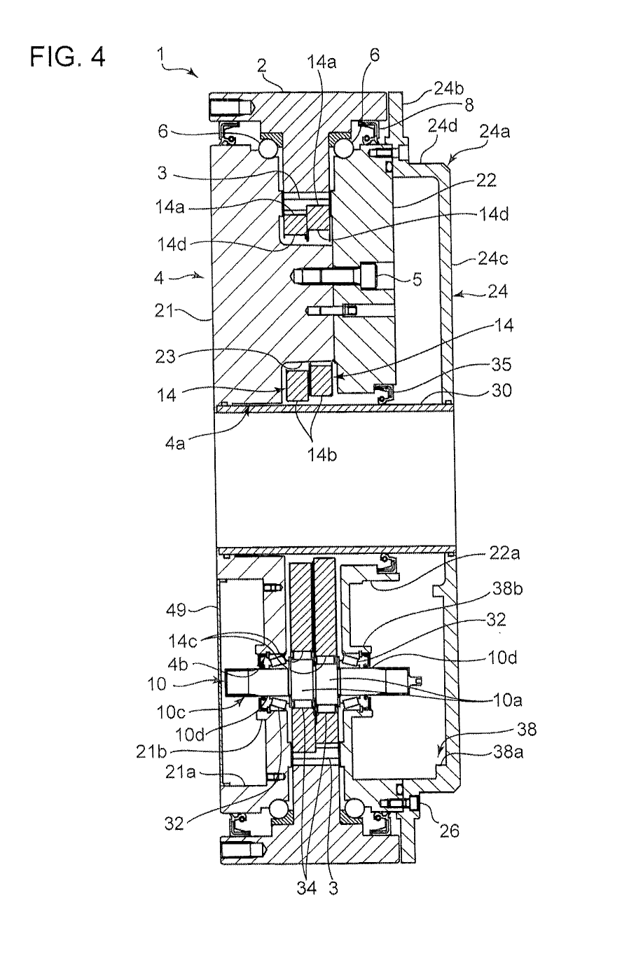

FIG. 3 is a side view of the gear device 1, when viewed rightwardly from the left side in FIG. 1, wherein the plugging members 49 are removed therefrom. As illustrated in FIG. 3, in this embodiment, the brake 16 is installed in each of two of the six recesses 21a (brake installation sections). The two brakes 16 are arranged, respectively, at the same circumferential positions as those of the two motors 12. In other words, each of the two pairs of the motor 12 and the brake 16 are installed and coupled to the same crankshaft 10. Thus, each of the brake 16 is operable to prevent rotation of a corresponding one of the crankshafts 10 directly receiving a driving force from the respective motors 12 installed in two of the motor installation sections 38. As illustrated in FIG. 4, the remaining crankshafts 10 are not installed with any of the motor 12 and the brake 16. It is to be understood that such a crankshaft 10 which is not installed with any of the motor 12 and the brake 16 may be removed.

An operation of the gear device 1 according to this embodiment will be described below.

Upon driving of the two motors 12, the two crankshafts 10 each installed with the motor 12 are rotated about their respective axes. Then, along with the rotation of the crankshafts 10, the eccentric portions 10a of the crankshafts 10 are eccentrically rotated. Thus, the oscillation gears 14 are rotated interlockingly with the eccentric rotation of the eccentric portions 10a, while sequentially changing a meshing position between the teeth 14a and the internal-tooth pins 3 of the outer cylinder 2. This causes relative rotation between the outer cylinder 2 and the carrier 4. In this embodiment, the outer cylinder 2 is immovable because it is fixed to the base, so that the carrier 4 is rotated about its axis according to oscillating rotation of the oscillation gears 14. Therefore, the carrier 4 and the turning body are relatively rotated with respect to the outer cylinder 2 and the base at a rotational speed reduced from a rotational speed of each of the motors 12.

A process for adjusting a torque to be generated from the gear device 1 will be described below. In this gear device 1, the motor 12 is installed two in number. This state may be continued without any modification when a torque generatable by the two motors 12 meets a required torque. However, if it fails to meet the required torque, the number of the motors 12 has to be increased. For this reason, in the gear device 1, respective numbers of the motors 12 and the brakes 16 to be installed can be changed. In this embodiment, each of the motor installation section 38 and the recess 21a (brake installation section) is formed six in number. Thus, each of the number of the motors 12 and the number of the brakes 16 can be changed within six. In this case, it is preferable that each of a group of the motors 12 and a group of the brakes 16 are arranged at circumferentially even intervals.

When the number of each of the group of motors 12 and the group of brakes 16 is changed, the bolt 26 is first unfastened, and the cover portion 24 is detached from the end plate portion 22. In this process, the motors 12 are left on the side of the end plate portion 22, and the axially outer segments 38a of the motor installation sections 38 are disengaged from the respective motors 12. Further, the plugging members 48 are detached from the base plate portion 21.

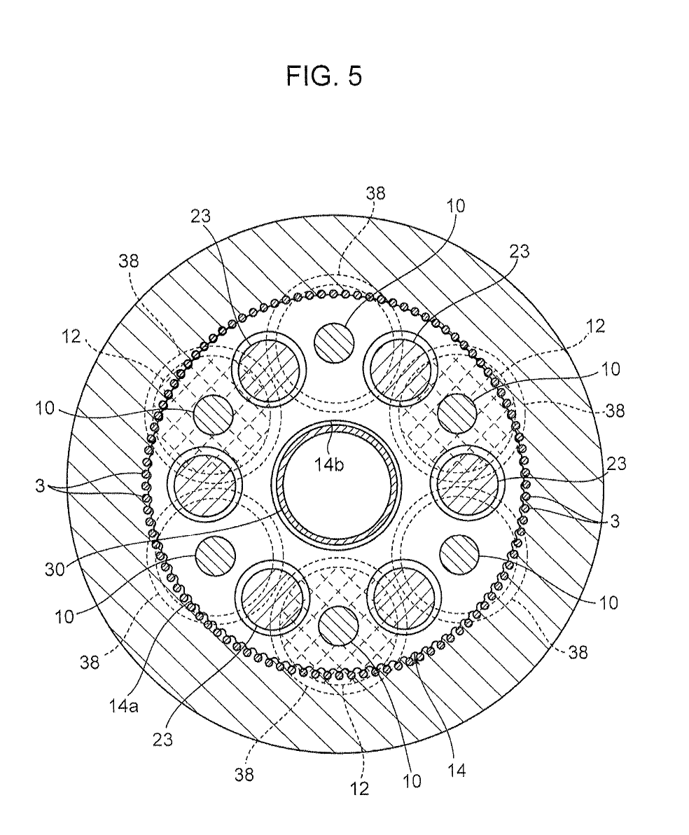

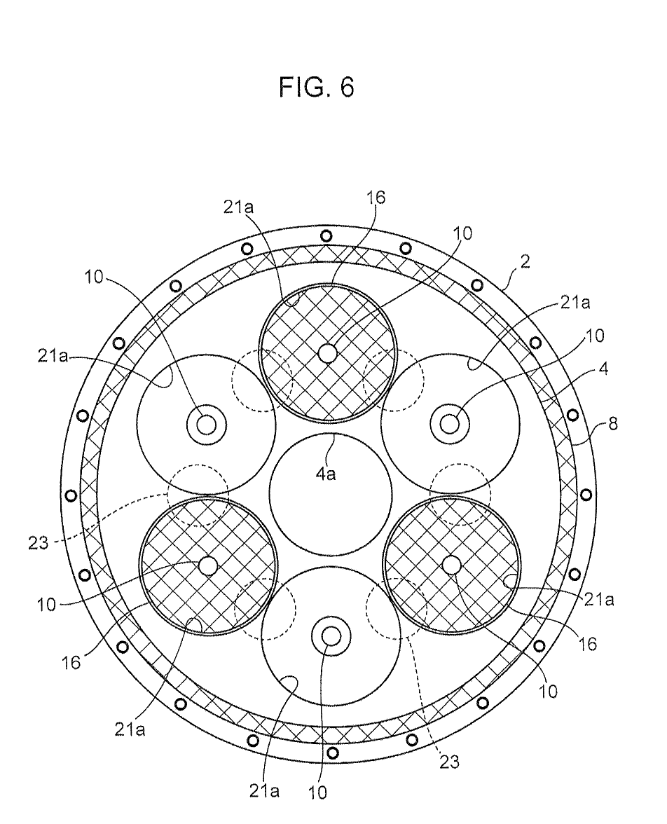

In the case where the number of the motors 12 is changed, for example, to three, it is necessary to achieve a state in which the three motors 12 are attached, respectively, to three of the six crankshafts 10, as illustrated in FIG. 5. Thus, one of the two motors 12 each currently installed and coupled to the crankshaft 10 is removed, and then the other two motors 12 are installed and coupled, respectively, to two of the remaining five crankshafts 10. In this process, it is preferable that the three motors 13 are alternately installed in the axially inner segments 38b of the six motor installation sections 38. On the other hand, as illustrated in FIG. 6, the three brakes 16 may be installed and coupled, respectively, to the remaining crankshafts 10 other than the three crankshafts 10 each provided with the motor 12. That is, the gear device 1 may be configured such that the crankshaft 10 installed with the motor 12 but not installed with the brake 16, and the crankshaft 10 installed with the brake 16 but not installed with the motor 12, are alternately arranged. This makes it possible to improve a circumferential weight balance. In this case, each of the brakes 16 is operable to prevent rotation of a corresponding one of the remaining crankshafts other than the crankshafts 10 each directly receiving the motor 12 installed in the motor installation section 38. It should be noted that each of the brakes 16 may be attached, respectively, to the crankshafts 10 each provided with the motor 12. After completion of the installation of the motors 12 and the brakes 16, the cover portion 24 and the plugging members 49 are attached, respectively, to the end plate portion 22 and the base plate portion 21. In this way, the process for adjusting a torque to be generated from the gear device 1 is completed.

As described above, in this embodiment, when the crankshafts 10 are driven by the motors 12 installed in the motor installation sections 38 of the carrier 4, relative rotation is caused between the carrier 4 and the outer cylinder 2. In this process, a magnitude of torque causing the relative rotation between the carrier 4 and the outer cylinder 2 depends on the number of the motors 12 driving the respective crankshafts 10. In this embodiment, the motors 12 are installed in only a part of the motor installation sections 38 provided in the carrier 4 but not installed in the remaining motor installation sections 38. Thus, one or more motors 12 can be additionally installed in the motor installation sections 38 each of which is not installed with the motor 12. Thus, for example, in a situation where a required torque is changed, or an actual torque is insufficient, the gear device 1 can be modified to generate a larger torque by increased the number of the motors 12. This makes it possible to readily cope with a change of the required torque. In this case, the number of the motors 12 can be increased without subjecting the carrier 4 to special processing. In other words, a plurality of types of gear devices 1 capable of generating different torques can be obtained using common components in terms of the outer cylinder 2, the carrier 2 and the main bearings 6. This also contributes to a reduction in burden of stocks.

Furthermore, in this embodiment, the crankshafts 10 can be maintained in a non-rotation state by activating the brakes 16 installed in the recesses 21a (brake installation sections). The brakes 16 are installed in only a part of the recesses 21a but not installed in the remaining recesses 21a. Thus, for example, in a situation where it is necessary to increase a braking force of the brakes 16, one or more brakes 16 can be additionally installed. In this case, the number of the brakes 16 can be increased without subjecting the carrier 4 to special processing. In other words, a plurality of types of gear devices 1 having different breaking forces can be obtained using common components in terms of the outer cylinder 2, the carrier 2 and the main bearings 6.

It should be understood that the present invention is not limited to the above embodiment, but various changes and modifications may be made therein without departing from the spirit and scope of the present invention as set forth in appended claims. As an example, in the above embodiment, each of the crankshaft 10, the motor installation section 38 and the recess 21a (brake installation section) is provided six in number. However, the present invention is not limited thereto. For example, each of the crankshaft 10, the motor installation section 38 and the recess 21a may be provided two or more, preferably, four or eight, in number.

Although FIG. 1 illustrates an example in which a plate disposed on the left side is constructed as the base plate portion 21, and a plate disposed on the right side is constructed as the end plate portion 22, the reversed structure may be employed. That is, the plate disposed on the left side may be constructed as the end plate portion 22, and the plate disposed on the right side may be constructed as the base plate portion 21. In this structure, the plate disposed on the right side is integrally formed with the shaft portions to serve as the base plate portion 21, and the cover portion 24 is fastened to this base plate portion 21. Further, each of the motor installation sections 38 comprises a segment provided in the base plate portion 21 and a segment provided in the cover portion 24, and the recesses 21a (brake installation sections) are provided in the end plate portion 22. Then, one or more motors 12 are installed between the base plate portion 21 and the cover portion 24, and one or more brakes 16 is installed to the end plate portion 22.

Each of the motor installation sections 38 is not limited to the structure having the axially outer segment 38a and the axially inner segment 38b. The motor installation section 38 may consist only of the axially outer segment 38a or may consist only of the axially inner segment 38b.

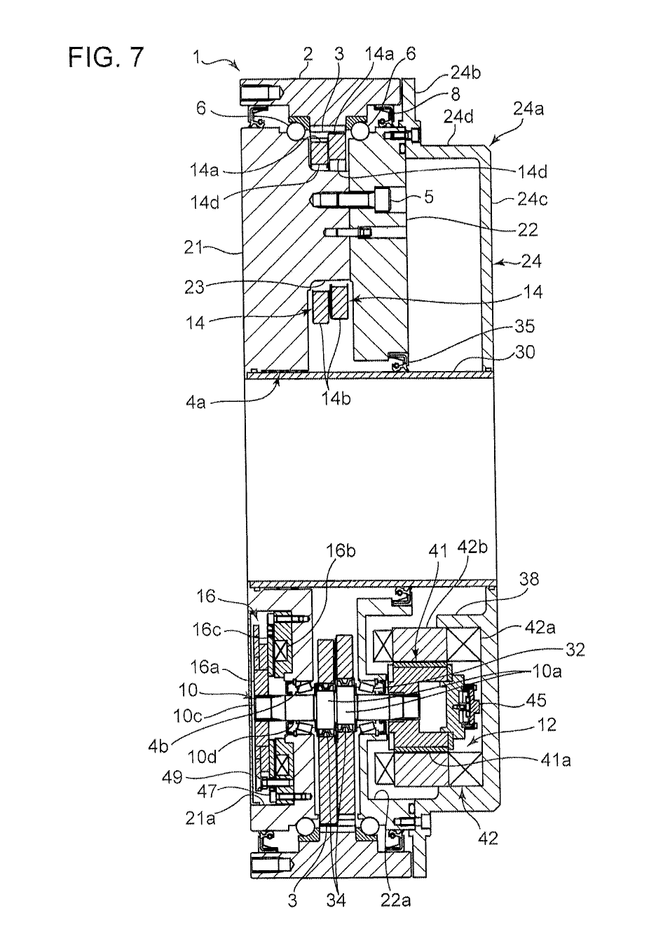

Although the above embodiment shows an example in which the motor 12 is composed of an axial gap motor, the embodiment is not limited thereto. As illustrated in FIG. 7, the motor 12 may be composed of a radial gap motor in which a stator 42 and a rotor 41 are radially opposed to each other. Specifically, the rotor 41 is formed into a circular cylindrical shape concentric with the crankshaft 10, and fixed to the crankshaft 10. A magnet 41a is fixed to an outer peripheral surface of the rotor 41. The stator 42 is disposed radially outward of the rotor 41 in such a manner as to allow an inner peripheral surface thereof to face the outer peripheral surface of the rotor 41. The stator 42 is fitted inside a corresponding one of the motor installation sections 38 provided in the cover portion 24. In this embodiment, each of the motor installation sections 38 consists only of the axially outer segment 38a provided in the cover portion 24, without the axially inner segment 38b provided in the end plate portion 22. It is to be understood that the motor installation section 38 in this example may also have the axially inner segment 38b provided in the end plate portion 22.

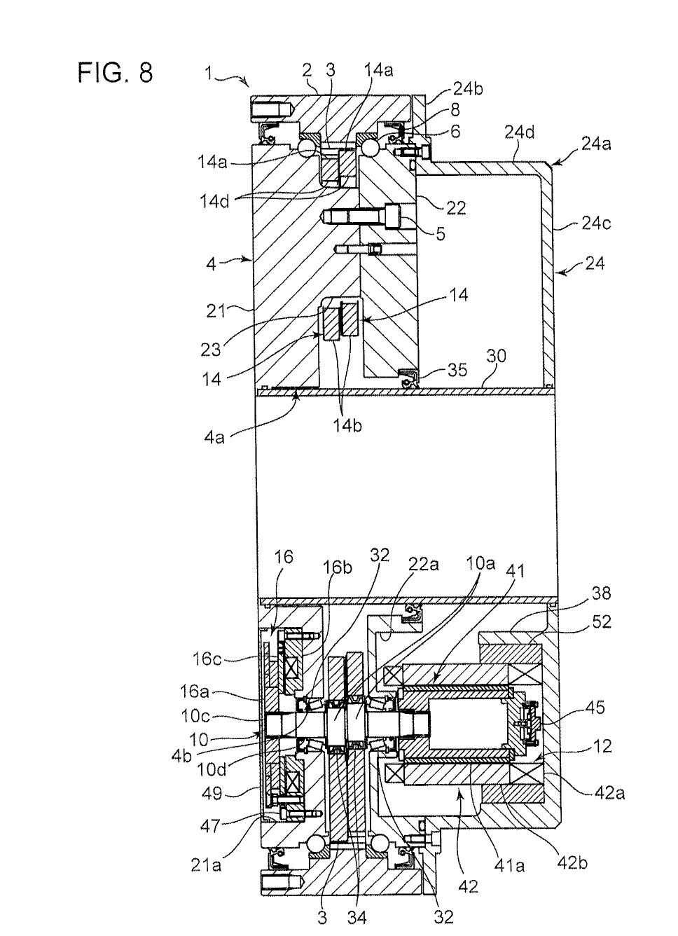

As illustrated in FIG. 8, each of the motor installation sections 38 may be formed in a size having an inner peripheral diameter enough to form a gap with respect to the stator 42 of the motor 12. In this embodiment, a spacer 52 capable of filling the gap between the motor installation section 38 and the stator 42 may be provided. That is, the motor installation section 38 is formed into an annular shape, so that a space is formed inside the motor installation section 38. This inside space is formed to allow the motor 12 to be inserted thereinto. The spacer 52 is formed into a tubular shape, and fitted into the inside space of the motor installation section 38. Then, the stator 42 of the motor 12 is fitted inside the spacer 52. In other words, the motor 12 is inserted into the inside space of the motor installation section 38, and, in this state, the spacer 52 is configured to fill the gap between the motor installation section 38 and the motor 12. Although FIG. 8 shows an example in which the motor 12 is composed of a radial gap motor, it is to be understood that the spacer 2 may be used in the case where the motor 12 is composed of an axial gap motor.

In the embodiment illustrated in FIG. 8, the gap between the motor installation section 38 and the motor 12 is filled by the spacer 52. In other words, the motor installation section 38 provided in the carrier 4 has an installation size greater than a size of the motor 12. This allows the motor 12 to be replaced with a motor 12 having a larger size. Thus, by replacement with a larger-size motor 12, the gear device 1 can generate a larger torque. In this case, the motor 14 can be replaced without subjecting the carrier 4 to special processing. In other words, a plurality of types of gear devices 1 capable of generating different torques can be obtained using common components in terms of the outer cylinder 2, the carrier 2 and the main bearings 6.

The above embodiments will be outlined below.

The above embodiments disclose an eccentric oscillation gear device which comprises: an outer cylinder; a carrier provided with a plurality of motor installation sections; a main bearing configured to permit relative rotation between the outer cylinder and the carrier; one or more motors installed in a part of the plurality of motor installation sections; and a crankshaft configured to be rotated in response to receiving a driving force from the one or more motors, in such a manner as to cause relative rotation between the outer cylinder and the carrier.

In the eccentric oscillation gear device disclosed in the above embodiments, when the crankshaft is driven by the one or more motors installed in a part of the motor installation sections of the carrier, relative rotation is caused between the carrier and the outer cylinder. In this process, a magnitude of torque causing the relative rotation between the carrier and the outer cylinder depends on the number of the motors driving the crankshaft. In the above embodiments, the one or more motors are installed in only a part of the motor installation sections provided in the carrier but not installed in the remaining motor installation sections. Thus, one or more motors can be additionally installed in the motor installation sections each of which is not installed with of the motor. Thus, for example, in a situation where a required torque is changed, or an actual torque is insufficient, the gear device can be modified to generate a larger torque by increased the number of the motors. This makes it possible to readily cope with a change of the required torque. In this case, the number of the motors can be increased without subjecting the carrier to special processing. In other words, a plurality of types of gear devices capable of generating different torques can be obtained using common components in terms of the outer cylinder, the carrier and the main bearing. This also contributes to a reduction in burden of stocks.

In the above embodiments, the carrier may be provided with a plurality of brake installation sections. In this case, the eccentric oscillation gear device may further comprise one or more brakes installed in a part of the plurality of brake installation sections and operable to prevent rotation of the crankshaft.

In the embodiment having this feature, the crankshaft can be maintained in a non-rotation state by activating the brake. The brake is installed in only a part of the brake installation sections but not installed in the remaining brake installation sections. Thus, for example, in a situation where it is necessary to increase a braking force, one or more brakes can be additionally installed. In this case, the number of the brakes can be increased without subjecting the carrier to special processing. In other words, a plurality of types of gear devices having different breaking forces can be obtained using common components in terms of the outer cylinder, the carrier and the main bearing.

In the above embodiments, each of the motor installation sections has a shape having an inside space. In this case, each of the one or more motors is inserted in the inside space of a corresponding one of the motor installation sections, wherein the eccentric oscillation gear device further comprises a spacer filling a gap between the motor and the corresponding motor installation section.

In the embodiment having this feature, the gap between the motor installation section and the motor is filled by the spacer. In other words, the motor installation section provided in the carrier has an installation size greater than a size of the motor. This allows the motor to be replaced with a motor having a larger size. Thus, by replacement with a larger-size motor, the gear device can generate a larger torque. In this case, the motor can be replaced without subjecting the carrier to special processing. In other words, a plurality of types of gear devices capable of generating different torques can be obtained using common components in terms of the outer cylinder, the carrier and the main bearing.

The above embodiments also disclose a method of adjusting torque of an eccentric oscillation gear device, wherein the eccentric oscillation gear device comprises: an outer cylinder; a carrier provided with a plurality of motor installation sections; a main bearing configured to allow relative rotation between the outer cylinder and the carrier; one or more motors installed in at least a part of the plurality of motor installation sections; and a crankshaft configured to be rotated in response to receiving a driving force from the one or more motors, in such a manner as to cause relative rotation between the outer cylinder and the carrier, the method comprising: selectively determining the number of the motors according to a required torque, within a total number of the motor installation sections; and installing the determined number of the motors, respectively, in the same number of ones of the motor installation sections, thereby adjusting a relative rotation torque to be generated between the outer cylinder and the carrier.

In the method of adjusting torque of an eccentric oscillation gear device, the number of motors to be installed in the motor installation sections can be increased or decreased according to the required torque.

As mentioned above, the present invention makes it possible to readily cope with a change of the required torque and contribute to a reduction in burden of stocks.

This application is based on Japanese Patent application No. 2014-173758 filed in Japan Patent Office on Aug. 28, 2014, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An eccentric oscillation gear device comprising:
an outer cylinder;
a carrier provided with a plurality of motor installation sections;
a main bearing configured to permit relative rotation between the outer cylinder and the carrier;
one or more motors installed in a part of the plurality of motor installation sections; and
a crankshaft configured to be rotated in response to receiving a driving force from the one or more motors, in such a manner as to cause relative rotation between the outer cylinder and the carrier.

2. The eccentric oscillation gear device as defined in claim 1, wherein the carrier is provided with a plurality of brake installation sections, and wherein the eccentric oscillation gear device further comprises one or more brakes installed in a part of the plurality of brake installation sections and operable to prevent rotation of the crankshaft.

3. The eccentric oscillation gear device as defined in claim 1, wherein each of the motor installation sections has a shape having an inside space, and wherein each of the one or more motors is inserted in the inside space of a corresponding one of the motor installation sections, and wherein the eccentric oscillation gear device further comprises a spacer filling a gap between the motor and the corresponding motor installation section.

4. The eccentric oscillation gear device as defined in claim 2, wherein each of the motor installation sections has a shape having an inside space, and wherein each of the one or more motors is inserted in the inside space of a corresponding one of the motor installation sections, and wherein the eccentric oscillation gear device further comprises a spacer filling a gap between the motor and the corresponding motor installation section.

5. A method of adjusting torque of an eccentric oscillation gear device, the eccentric oscillation gear device comprising: an outer cylinder; a carrier provided with a plurality of motor installation sections; a main bearing configured to permit relative rotation between the outer cylinder and the carrier; one or more motors installed in at least a part of the plurality of motor installation sections; and a crankshaft configured to be rotated in response to receiving a driving force from the one or more motors, in such a manner as to cause relative rotation between the outer cylinder and the carrier, the method comprising: selectively determining the number of the motors according to a required torque, within a total number of the motor installation sections; and installing the determined number of the motors, respectively, in a same number of ones of the motor installation sections, thereby adjusting a relative rotation torque to be generated between the outer cylinder and the carrier.
